(19) United States
(12) Patent Application Publication
(10) Pub. No.: US 2005/0224461 A1
(43) Pub. Date: Oct. 13, 2005

(54) Method for metallizing titanate-based ceramics

(76) Inventor: Jiri Roubal, Bad Uberkingen (DE)

Correspondence Address: SCULLY SCOTT MURPHY & PRESSER, PC, 400 GARDEN CITY PLAZA, SUITE 300, GARDEN CITY, NY, 11530, US

(21) Appl. No.: 10/505,907

(22) PCT Filed: Feb. 19, 2003
(86) PCT No.: PCT/EP03/01681

§ 371 Date: Jun. 6, 2005

(30) Foreign Application Priority Data
Feb. 26, 2002 (DE) 102-08-120.4

(51) Int. Cl. B44C 1/22

(52) U.S. Cl. 216/96

(57) ABSTRACT

The invention relates to a method for metallizing titanate-based ceramics, which is characterized by: (a) etching the ceramics, (b) activating the ceramics etched in step (a), and (c) chemically metallizing the ceramics obtained in step (b). In step (a), a sulfur solution in the concentration range of from 65 to 90% by weight is used for etching at a temperature of from 140 to 170° C.

The invention relates to a method for metallizing titanate-based ceramics, wherein the ceramics are etched in sulfuric acid.

The treatment sequence described below is normally used for the wet chemical metallization of ceramic parts:
1. etching
2. activation
3. electroless metal deposition, resulting in a conductive surface
4. optionally further metal deposition, galvanic or electroless depending on requirements.

In order to obtain a firm bonding of the metal layer to the substrate, the metal layer must be anchored in the surface of the base material. This is achieved if the surface has a certain roughness in the microrange and a cavity-like structure.

In some cases, such structures exist already after production of the ceramic substrates, however in other cases, the surface of the substrates is smooth, and thus the “etching” treatment step must be applied so that adhering coatings can be deposited. The etching agent must attack the ceramics inhomogeneously so that the desired structure with numerous microcavities results. Etching agents that homogeneously corrode the base material uniformly are less suitable for pretreatment since the action of such etching agents does not result in the structures as described above.

Ceramics based on titanates, for example barium titanate or titanates containing rare earth elements, are used for the production of component parts and in specific use cases have to be metallized for use in electronics. The surface of the ceramic parts is more or less smooth depending on the composition and the method of production. Ceramic parts having smooth surfaces must be etched before metallization.

A method is described in DE-OS 3 345 353, in which ceramics based on aluminum oxide, barium titanate and beryllium oxide are etched in hydrofluoric acid-containing mediums. Metallization of barium titanate capacitor ceramics is described in example 2 of this specification. Following etching in concentrated hydrofluoric acid, an adhesion of 5 N/mm is achieved. However, the use of fluorides is undesirable for ecological reasons. Furthermore, strict safety measures must be observed when handling hydrofluoric acid and fluoride-containing solutions.

A method is described in DE-OS 3 523 957, in which the ceramics are pretreated in alkali metal hydroxide melts or in an acid melt, with an adhesion promoter and/or a sensitizer and/or an activator and/or a catalyst being added to the etching medium. In example 5 of this specification, the metallization of barium titanate ceramics is described. An ammonium hydrogen sulfate melt is used for roughening, to which tin(II) acetate is added. The ceramic parts were treated for 10 minutes at 200° C. The disadvantage of this method is, however, that the use of melts requires a high outlay in terms of apparatus. The relatively high working temperatures are furthermore linked with increased energy consumption and there is the danger of the ceramics being damaged by the thermal load.

A method for metallizing aluminum oxide ceramics is described in DE-OS 3 737 757, in which concentrated phosphoric acid is used for etching at 250 to 360° C. The disadvantage here, however, is also the use of high temperatures, which on the one hand results in a high expenditure of energy and on the other can also lead to the ceramics being damaged.

A method for metallizing aluminum oxide ceramics is described in DE-OS 3 833 441. A phosphoric acid/sulfuric acid mixture is used as the etching agent at 220° C. However, at such high temperatures, there is the risk of acid vapors forming, which are highly corrosive and should thus be avoided as far as possible. A relatively high outlay in terms of apparatus is furthermore necessary owing to the high temperatures.

An etching agent based on inorganic acids such as hydrofluoric acid, hydrochloric acid, phosphoric acid, nitric acid and other inorganic acids is suggested in EP 0 254 201 A1. The treatment of ceramics in concentrated phosphoric acid at 175° C. and subsequently in an ammonium biflouride solution is described in the example. Such a two-step method is, however, disadvantageous for reasons of procedural economy. Fluoride compounds are furthermore undesirable for ecological reasons.

The object forming the basis for this invention is thus to provide a method for metallizing ceramics, which does not have the disadvantages described above.

The object is solved by means of the method according to patent claim 1.

Advantageous embodiments of this method are described in the further claims.

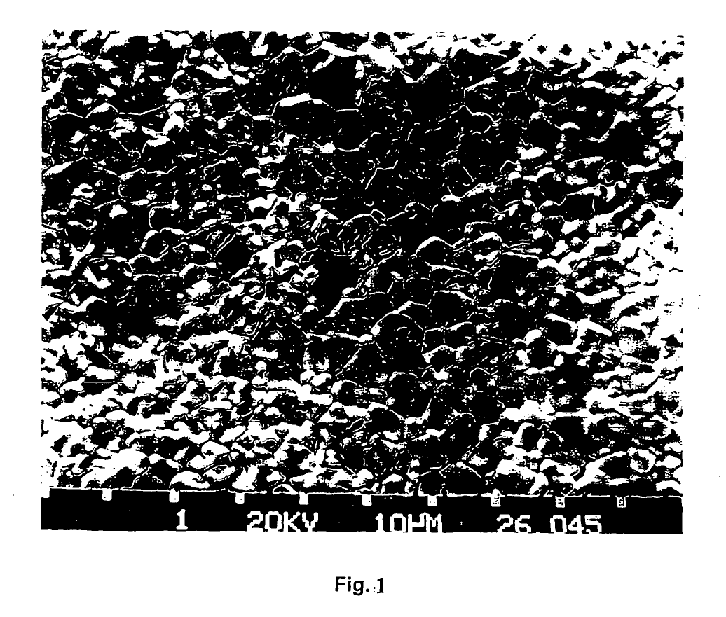

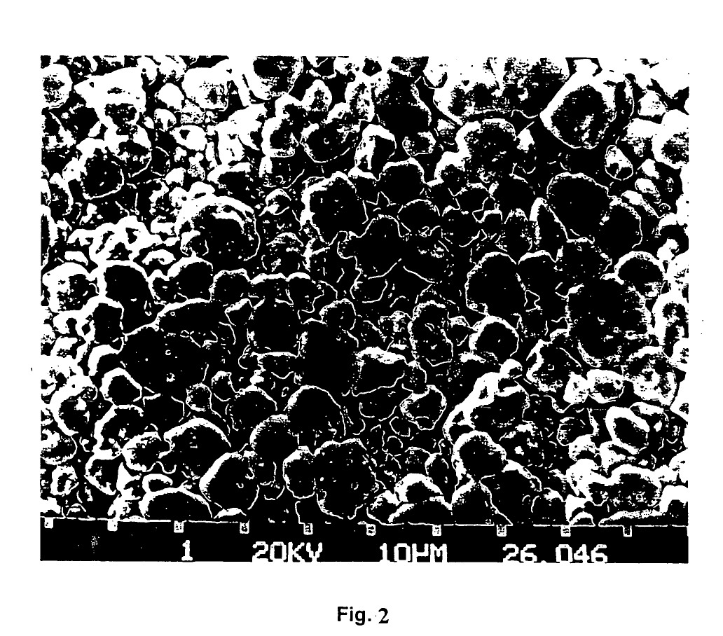

FIGS. 1 and 2 show scanning electron micrographs of a surface of ceramics consisting of rare earth titanates as produced in example 1 both before (FIG. 1) and after (FIG. 2) etching according to the invention.

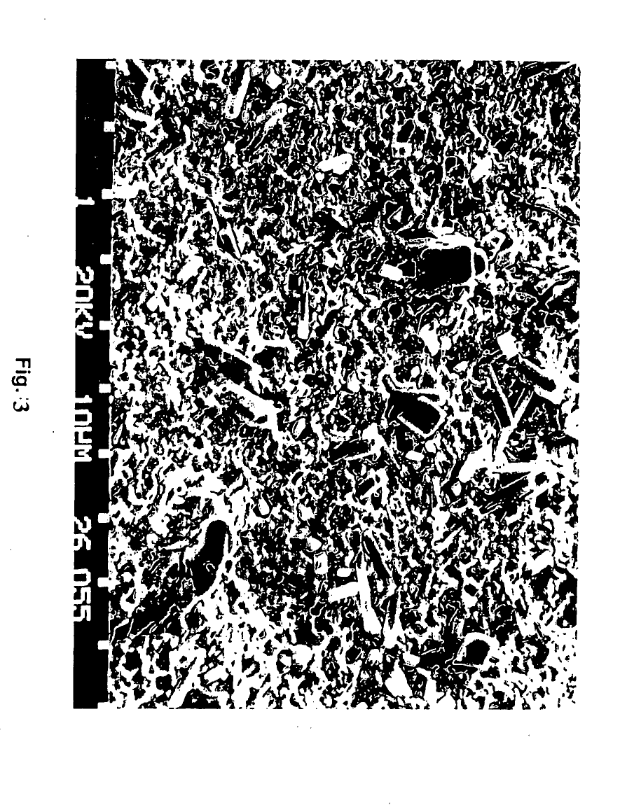

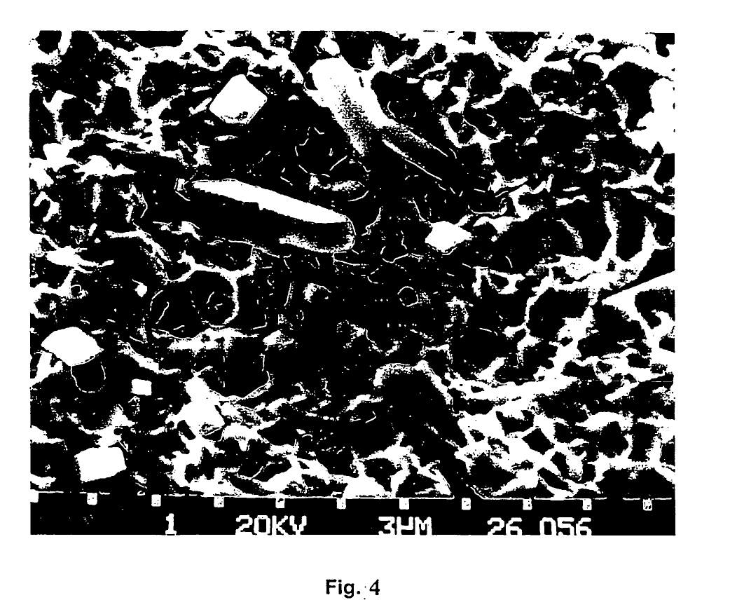

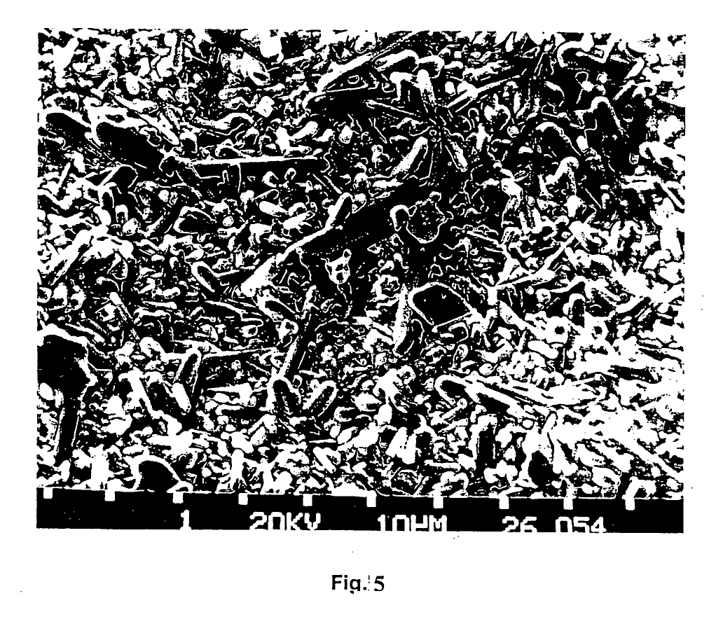

FIGS. 3 and 4 show scanning electron micrographs at different magnifications of a surface of barium titanate-based ceramics as produced in example 14 after etching according to the invention. In comparison thereto, FIG. 5 shows the same surface before etching.

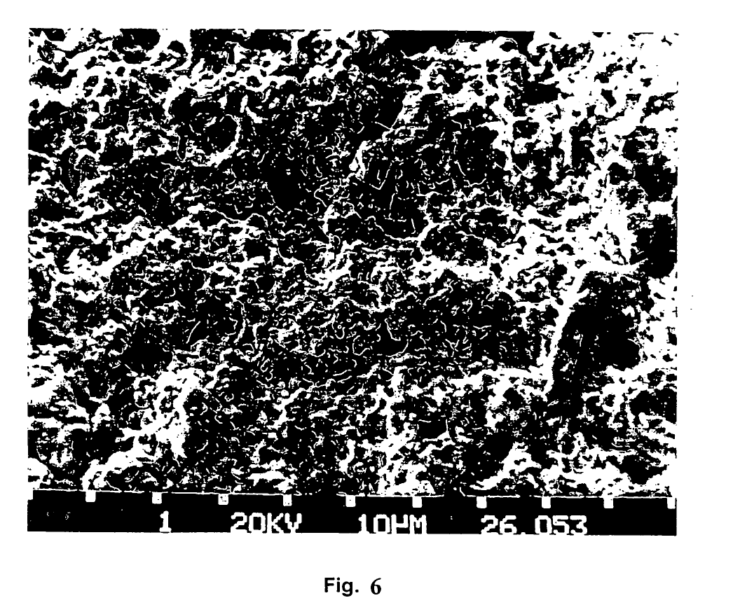

FIG. 6 shows a scanning electron micrograph of barium-samarium titanate-based ceramics after etching according to example 15 of this invention.

When using the method according to the present invention, the following advantages are achieved as compared to the methods known to date:
in comparison to the prior art, lower temperatures are used during etching,
the use of hydrofluoric acid or fluorides is no longer necessary,
the complicated handling of hydroxide or salt melts is no longer necessary.

The method relates to metal titanate-based ceramics, with alkaline earth metals, for example calcium and barium, rare earth elements such as, for example, lanthanum and samarium, as well as other elements being used in small proportions as metals in order to achieve the desired properties of the ceramic parts.

It has now been found that sulfuric acid solutions are highly suitable for etching titanate-based ceramics. Structures enabling excellent adhesion of the subsequently deposited metal layers thereby result on the surface of the ceramics.

The concentration of sulfuric acid is 65 to 90% by weight, preferably 70 to 80% by weight.

At concentrations of less than 65% by weight, the ceramics are only slightly attacked and the results as regards adhesion are unsatisfactory. In order to obtain expedient results as regards adhesion, sulfuric acid is used at a concentration of 65 to 90% by weight, preferably 70 to 80% by weight. Under these conditions, the ceramics are inhomogeneously corroded and cavity-like structures in the microrange form, which enable a firm anchoring of the subsequently deposited metal coating. Concentrations of greater than 90% by weight are not advantageous since considerable acid mist formation, which should be avoided as far as possible, already occurs at temperatures of about 130° C. Furthermore, cavity-like microstructures cannot be achieved with concentrated sulfuric acid and, as a result, the subsequently applied metal coating only displays a low degree of adhesion.

The working temperature of the solution during etching is 130 to 170° C., preferably 140 to 160° C. The temperature range of between 145 and 155° C. has proven particularly advantageous. The temperature and concentration are preferably set such that the duration of treatment is in the range of 5 to 20 minutes.

At temperatures lower than 130° C., the attack on the surface of the ceramics occurs too slowly or the ceramics are not sufficiently etched. The intensity of the etching increases with the temperature used. Temperatures above 170° C. are not preferred since the formation of acid mist then becomes quite considerable.

The upper limit for the temperature used is furthermore restricted by the concentration-dependent boiling point of the sulfuric acid solution since no work should be carried out above the boiling point.

The vaporization of sulfuric acid should be kept as low as possible for reasons of environmental engineering. As the concentration of sulfuric acid and the temperature increases, so does the proportion of sulfuric acid in the vapor phase. The vaporization of sulfuric acid is linked with the formation of white acid fumes. It is therefore advantageous to select the concentration and temperature such that the formation of acid vapors is minimal. From this point of view, lower temperatures should be selected for higher concentrations.

Following etching, the ceramic parts are to be thoroughly rinsed with water. In order to remove loose ceramic particles from the surface, it is advantageous to support rinsing by means of ultrasound. In order to achieve an even more thorough cleaning, acidic, alkaline or neutral solutions, which may contain surfactants, can be used to clean the surface of the ceramics following etching. Cleaning can preferably also be supported by means of an ultrasound treatment.

After rinsing, and optionally an additional cleaning step, the surface of the ceramics is activated. Commercially available, known methods, for example based on palladium compounds, can be used for this purpose.

Following activation, a metal layer is electrolessly deposited on the surface of the ceramics. Electroless baths, for example electroless nickel or copper baths, are used for this purpose.

These baths contain metal salts, complexing agents, stabilizers, reducing agents and other additives. Hypophosphite or a boron compound such as, for example, dimethylaminoborane, are used as reducing agents in the nickel baths available on the market. The electroless copper baths available on the market normally contain formaldehyde as the reducing agent.

Once the surface of the ceramics has been coated in an electroless bath, further layers can be deposited as required either electrolessly or galvanically. The following combinations are cited as examples: copper, tin or tin-lead; copper, nickel, gold; copper, nickel. The metal layers can be structured using known methods such that metal patterns are formed on the surface of the ceramics.

The present invention is described in more detail below by means of examples.

### EXAMPLES

### Example 1

Ceramic parts consisting of rare earth titanates were treated in sulfuric acid (74% by weight) at 150° C. for 10 minutes, were subsequently rinsed in water and dried.

The effect of the etching solution is clear from the scanning electron micrographs (FIGS. 1 and 2). FIG. 1 shows the ceramics before etching. The surface is comparatively smooth and the grain boundaries can be clearly recognized. FIG. 2 shows the surface after etching. In comparison to FIG. 1, it can be observed that the ceramics were attacked inhomogenously and primarily at the grain boundaries. Recesses and cavities were formed, which enable an anchoring of the subsequently deposited metal deposit.

Following etching, the ceramics were activated in a conmercially available activator based on palladium colloid and were electrolessly coated with nickel in a chemical nickel bath, in which dimethylaminoborane was used as the reducing agent. Copper was galvanically deposited on this conductive layer from an acidic copper bath. The thickness of the layer was 20 μm.

A good adhesion (6 N/cm) was observed when peeling off the metal layer (DIN 53494).

### Examples 2 to 13

Ceramic parts of the same type as described in example 1 were etched in various sulfuric acid solutions, the sulfuric acid concentration, the temperature and the exposition time being varied in accordance with the details given in table 1. The adhesion was subsequently evaluated in accordance with DIN 53494.

The results are indicated in the following table 1.

TABLE 1

| Example | Sulfuric acid | Temperature | Duration of | Adhesion |
|---|---|---|---|---|
| no. | conc. [wt. %] | [° C.] | treatment [min] | [N/cm] |
| 1 | 74 | 150 | 10 | 6.0 |
| 2 | 69 | 150 | 20 | 10.0 |
| 3 | 74 | 130 | 60 | 8.0 |
| 4 | 74 | 130 | 180 | 11.5 |
| 5 | 74 | 140 | 20 | 5.9 |
| 6 | 74 | 140 | 30 | 12.8 |
| 7 | 74 | 150 | 20 | 13.5 |
| 8 | 74 | 160 | 5 | 4.0 |
| 9 | 74 | 160 | 10 | 15.5 |
| 10 | 80 | 140 | 20 | 5.5 |
| 12 | 87 | 150 | 20 | 5.2 |
| 13 | 87 | 150 | 60 | 6.3 |

### Example 14

Small plates made of barium titanate-based ceramics were treated in 74% sulfuric acid at 150° C. for 30 minutes. FIGS. 3 and 4 show scanning electron micrographs at different magnifications of the surface of the ceramics after etching. The surface before etching is shown in FIG. 5 for comparison. As can be clearly seen from the scanning electron micrographs, cavity-like recesses have formed on the surface as a result of etching.

Ceramic parts of the same type were rinsed in water following etching, the rinsing being intensified by means of ultrasound. Following activation, chemical nickel coating and galvanic copper coating, as described in example 1, adhesion was quantitatively ascertained in the peel test (DIN 53494). Values of between 6 and 7 N/cm were measured. An increase in the exposition time in the etching bath to 90 minutes resulted in adhesion values of 14 to 16 N/cm.

### Example 15

A baruim-samarium tutabate-based ceramic part was etched in 74% sulfuric acid at 150° C. for 30 minutes. Following rinsing and activation, as per example 14, the ceramic part was metallized in a chemical copper bath, in which formaldehyde was used as the reducing agent. The deposit was then galvanically reinforced in the acidic copper bath. An adhesion of 10 N/cm was ascertained in the peel test (DIN 53494).

This good value for adhesion is consistent with the surface structure achieved as a result of etchaing. The scanning electron micrograph of the surface of the ceramics following etching is shown in FIG. 6.

### COMPARATIVE EXAMPLES

The same ceramic parts as in example 1 were treated in concentrated sulfuric acid (96% by weight) at 150° C. for different lengths of time. Following activation, chemical nickel coating and galvanic copper coating, carried out as per example 1, the adhesion was ascertained in accordance with DIN 53494.

| Duration of treatment [min] | Adhesion [N/cm] |
|---|---|
| 20 | 0 |
| 60 | <2 |
| 90 | 2 |

It can be clearly seen from the comparative examples that the surfaces of ceramics etched with concentrated sulfuric acid only have a low degree of adhesion.

1. Method for the wet chemical metallization of titanate-based ceramics, comprising the steps of:
(a) etching the ceramics,
(b) activating the ceramics etched in step (a),
(c) chemically metallizing the ceramics obtained in step (b),
characterized in that in step (a), a sulfuric acid solution in a concentration range of 65 to 90% by weight is used for etching at a temperature of 130 to 170° C.

2. Method according to claim 1, characterized in that the sulfuric acid is used in the concentration range of 70 to 80% by weight at 140 to 160° C.

3. Method according to one of claims 1 or 2, characterized in that the ceramics are subsequently galvanically or chemically metallized in a step (d).

4. Method according to one or more of claims 1 to 3, characterized in that the ceramics contain barium titanate.

5. Method according to one or more of claims 1 to 4, characterized in that the ceramics contain rare earth elements.

6. Method according to one or more of claims 1 to 5, characterized in that the ceramics are chemically coated with copper in step (c).

7. Method according to one or more of claims 1 to 6, characterized in that the ceramics are chemically coated with nickel in step (c).

8. Method according to one or more of claims 1 to 7, characterized in that following etching and before step (b), the ceramics are cleaned in a neutral solution and/or an alkaline solution and/or an acidic solution.

9. Method according to claim 8, characterized in that cleaning is supported by means of ultrasound.
